(19) United States
(12) Patent Application Publication
(10) Pub. No.: US 2009/0313516 A1
(43) Pub. Date: Dec. 17, 2009

(54) ENHANCED HYBRID AUTOMATIC REPEAT REQUEST FOR LONG TERM EVOLUTION

(75) Inventors: Sung-Hyuk Shin, Northvale, NJ (US); Erdem Bala, Farmingdale, NY (US); Philip J. Pietraski, Huntington Station, NY (US); Joseph S. Levy, Merrick, NY (US); Donald M. Grieco, Manhasset, NY (US); Mohammed Sammour, Alrabieh (JO)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/485,483

(22) Filed: Jun. 16, 2009

Related U.S. Application Data
(60) Provisional application No. 61/061,924, filed on Jun. 16, 2008.

(51) Int. Cl. H04L 1/18; G06F 11/14

(52) U.S. Cl. 714/748; 714/E11.113

(57) ABSTRACT

A method and an apparatus are provided for receiving a transport block that is segmented into a plurality of code blocks (CBs), each CB having an attached cyclic redundancy check (CRC), decoding each of the plurality of CBs with attached CRC, determining whether each CRC fails, and in response to a determination that a CRC has failed, transmitting a CB index number of the CB attached to the CRC that has failed. Also provided are a method and an apparatus for a transmitter receiving an index number of a CB for retransmission (CBSIRT) attached with a CRC that has failed, determining the CB that correspond to the CRC that has failed based on the CBSIRT, and retransmitting the failed CB in a subsequent transmission time interval (TTI).

### CROSS REFERENCE TO RELATED APPLICATIONS

This application claims the benefit of a U.S. Provisional Application Ser. No. 61/061,924 filed on Jun. 16, 2008, which is incorporated by reference as if fully set forth.

### FIELD OF INVENTION

This application is related to wireless communications.

### BACKGROUND

In third generation partnership project (3GPP) long term evolution (LTE) wireless communications systems, for data channels such as physical uplink shared channel (PUSCH) and physical downlink shared channel (PDSCH), a hybrid automatic repeat request (HARQ) process is defined for each transport block (TB) within a 1 ms transmission time interval (TTI). In each HARQ process, a 24 bit cyclic redundancy check (CRC) is attached to each TB. The TB CRC is used for error detection and for generating a HARQ positive acknowledgement (ACK) or negative acknowledgement (NACK). If the size of the TB, including the attached TB CRC, exceeds a maximum turbo code block (CB) size, then the TB is segmented into multiple CBs. According to the 3GPP standard specification, the maximum CB size is 6144 bits. If segmentation of the TB occurs, then an additional CRC is attached to each CB. The CB CRC may be utilized at the receiver to enhance power saving and efficient memory utilization.

In the LTE standard, one HARQ process serves one TB for a given 1 ms TTI. If retransmission is required, the current standard dictates the transmission of the full TB. In order to support peak LTE data rates up to 100 Mbps or more, especially in downlink (DL), a TB may consist of up to sixteen (16) or more code blocks (CBs) within a TTI. At the receiver, if one of the CBs is in error, then a TB CRC failure occurs. As a result of the failure, a NACK is signaled to the transmitter for HARQ feedback. Upon receiving the NACK, the transmitter retransmits the same TB, and therefore the same CBs, in an appropriate later TTI. In an incremental redundancy (IR) method, the retransmission may use a different redundant version (RV). In an adaptive HARQ scheme, the retransmission may use a different modulated coding scheme (MCS) or resource block (RB) allocation.

During an initial transmission, the transport block size (TBS) of a HARQ process is selected based on the reported channel quality indicator (CQI) as well as resource issues. For example, if a high CQI is reported by a wireless transmit receive unit (WTRU) for a predefined channel, then the maximum TBS allowed by the WTRU for a predefined number of RBs may be chosen by using 64 quadrature amplitude modulation (QAM) and a high code rate (e.g., ⅞ code rate) so that the maximum data rate for the WTRU may be provided. The actual channel condition for a given TTI may differ significantly from the reported CQI. The channel conditions may have changed more recently than what the WTRU had measured. Based on the constraints of the existing HARQ protocol, evolved Node-B (eNB) may retransmit the same TB, which continues to fail until the time-out threshold (i.e., maximum number of retransmissions).

### SUMMARY

A method and an apparatus are provided for receiving a transport block that is segmented into a plurality of CBs, each CB having an attached CRC, decoding each of the plurality of CBs with attached CRC, determining whether each CRC fails, and in response to a determination that a CRC has failed, transmitting a CB index number of the CB attached to the CRC that has failed. Also provided are a method and an apparatus for a transmitter receiving an index number of a CB for retransmission (CBSIRT) attached with a CRC that has failed, determining the CB that correspond to the CRC that has failed based on the CBSIRT, and retransmitting the failed CB in a subsequent transmission time interval (TTI).

A method and an apparatus are provided for enhancing HARQ for LTE, LTE plus (LTE+), and high speed packet access plus (HSPA+) using CB CRCs to perform HARQ retransmissions and HARQ combining on the CB basis rather than on the TB basis. During retransmissions, the proposed enhanced HARQ method may increase channel coding gain, spectral efficiency, or both. This advantage is gained by not retransmitting CBs for which the CB CRC has passed. Here, the receiver uses CB index signaling to indicate which CBs within a TB have passed or failed their respective CRC. For example, signaling mechanism is proposed to give the transmitter information about the first CB CRC failed CB to reduce the number of retransmitted CBs. For the enhanced HARQ method, it is beneficial to introduce several options for efficient CB index signaling in conjunction with ACK or NACK signaling.

### BRIEF DESCRIPTION OF THE DRAWINGS

A more detailed understanding may be had from the following description, given by way of example in conjunction with the accompanying drawings wherein:

FIG. 1 shows an example wireless communication system including a plurality of WTRUs and an eNB in accordance with one embodiment;

FIG. 2 is a functional block diagram of a WTRU and the eNB of the wireless communication system shown in FIG. 1;

FIG. 3 shows an example of a TB processing for CB based HARQ transmission at a receiver;

FIG. 4 shows a flow diagram of a receiver for a CB based HARQ transmission;

FIG. 5 shows an example of code block based HARQ retransmission when the CB CRC failed is at a specified CB;

FIG. 6 is an example of signaling a CB CRC failed CB starting index with limited indexing; and

FIG. 7 is a flow diagram of a transmitter for a CB based HARQ retransmission.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, evolved Node-B, a site controller, an access point (AP), or any other type of interfacing device capable of operating in a wireless environment.

As used hereafter, the terms “receiver” and “transmitter” are defined as including either a WTRU, a base station, or both. The “transmitter” may communicate with the “receiver,” and vice versa.

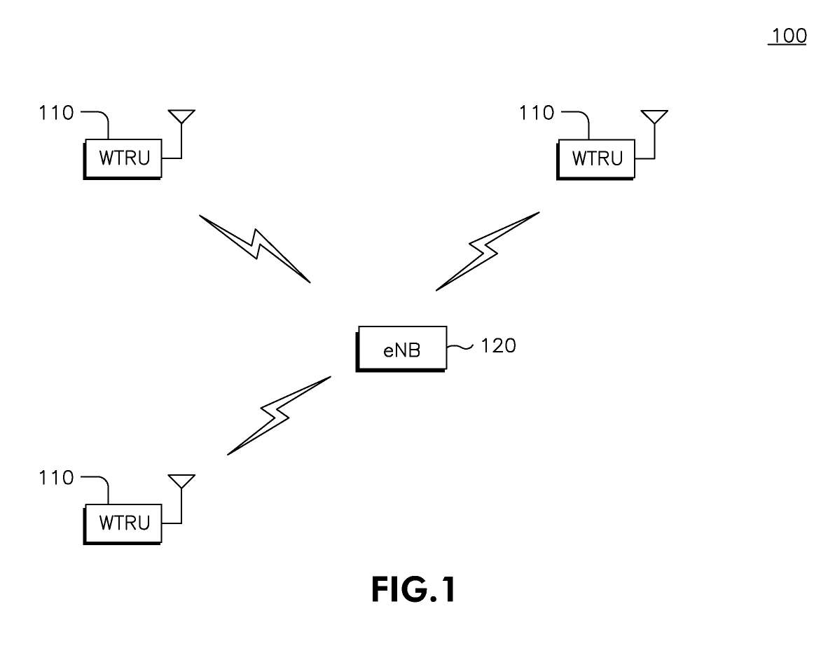

FIG. 1 shows a wireless communication system 100 including a plurality of WTRUs 110 and an eNB 120. As shown in FIG. 1, the WTRUs 110 are in communication with the eNB 120. Although three WTRUs 110 and one eNB 120 are shown in FIG. 1, it should be noted that any combination of wireless and wired devices may be included in the wireless communication system 100.

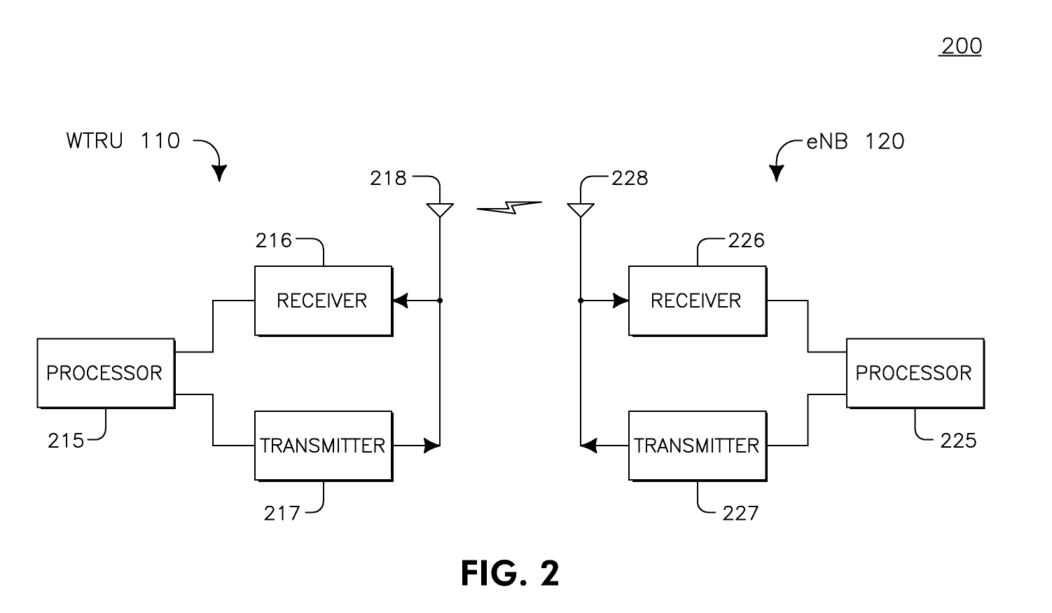

FIG. 2 is a functional block diagram 200 of a WTRU 110 and the eNB 120 of the wireless communication system 100 of FIG. 1. As shown in FIG. 2, the WTRU 110 is in communication with the eNB 120.

In addition to the components that may be found in a typical WTRU, the WTRU 110 includes a processor 215, a receiver 216, a transmitter 217, and an antenna 218. The receiver 216 and the transmitter 217 are in communication with the processor 215. The antenna 218 is in communication with both the receiver 216 and the transmitter 217 is configured to facilitate the transmission and reception of wireless data.

In addition to the components that may be found in a typical eNB, the eNB 120 includes a processor 225, a receiver 226, a transmitter 227, and an antenna 228. The receiver 226 and the transmitter 227 are in communication with the processor 225. The antenna 228 is in communication with both the receiver 226 and the transmitter 227 is configured to facilitate the transmission and reception of wireless signals.

When there are multiple code blocks (CBs), K, in a TB, for example, transport block size (TBS) is greater than 6144 bits, each CB includes a code block cyclic redundancy check (CB CRC) sequence of 24 bits. The receiver processes the individual CBs separately in a pipeline including de-rate matching and turbo decoding, starting with the first CB.

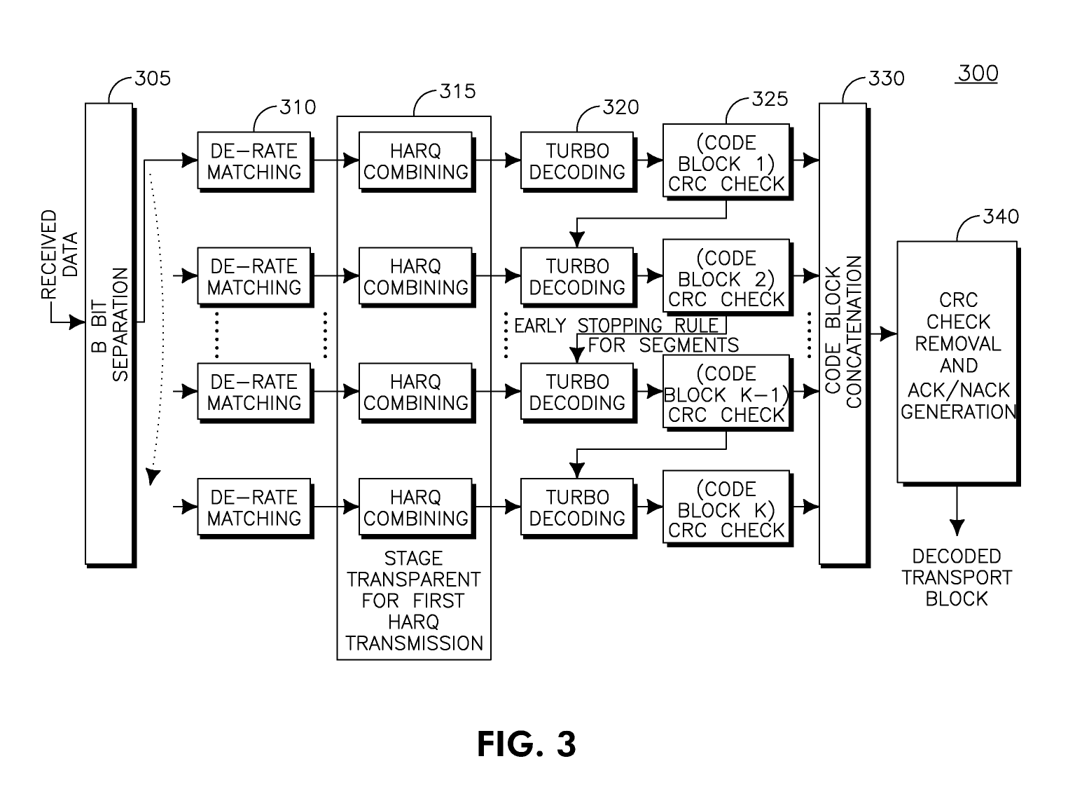

FIG. 3 shows an example of processing a TB at a receiver. In a case that there are multiple CBs in a TB, the TB is segmented into a sequence with multiple CBs 305. The CBs are sent to de-rate matching entities 310 for the individual CB and subsequently to HARQ combining entities 315. The CBs are decoded using turbo decoder 320. The CB CRC checked is processed per CB base by CRC check entities 325. The CB CRC check is sent to the CB concatenation entity 330. The CRC tagged to the CB is removed and either an ACK or a NACK is generated in a CRC check and ACK/NACK processing entity 340. The processing of each CB may be done sequentially (i.e., in pipeline). Alternatively, all the CBs may be processed in parallel. Or, a hybrid processing method, combining parallel processing and sequential processing may be implemented for processing each TB in the receiver chain.

By using the CB CRC, the receiver may stop processing when one of the CBs is in error, and declare that the corresponding TB is in error. Consequently, a NACK is then sent to the transmitter. Each CB may be transmitted in different orthogonal frequency division multiplexing (OFDM) symbols, different sub-carriers, or both. Accordingly, at the receiver, the CB CRC check result 325 for one CB may be different than that for another CB.

Assume that a first number of CBs, i, (where, 0<i<K) have CB CRCs “passed” indicating successfully decoded CBs, but the CBᵢ₊₁ has a CB CRC “failed” indicating an error in transmitting or decoding the CB. In this case, it is redundant for the transmitter to resend the first i CBs during the corresponding HARQ process retransmissions.

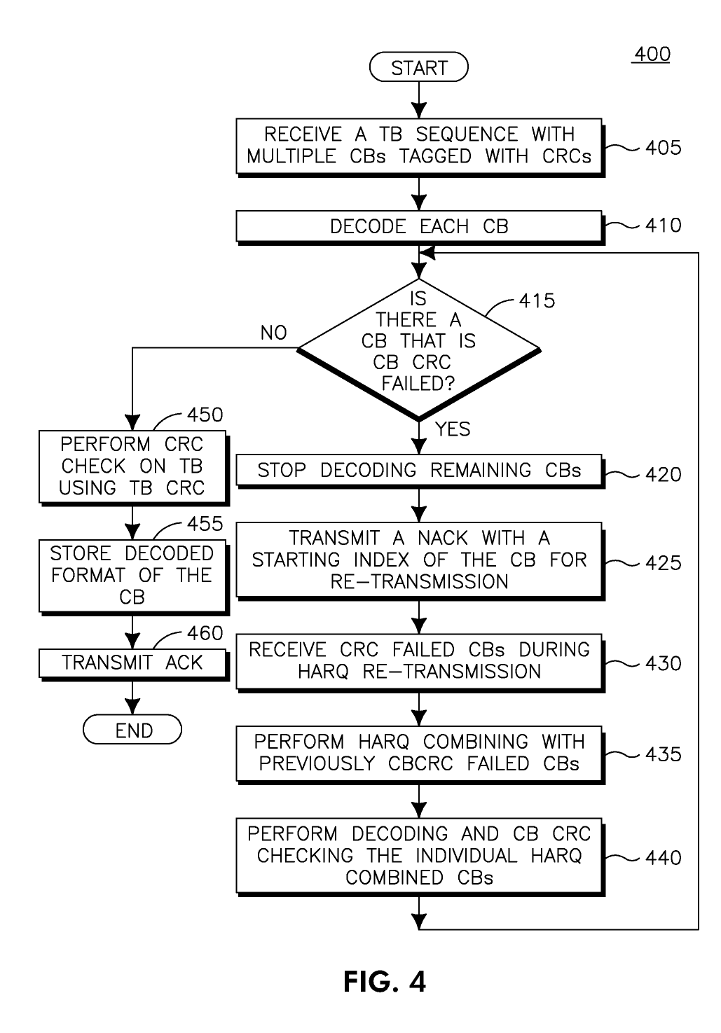

FIG. 4 shows a flow diagram 400 describing HARQ transmission with multiple CBs in a TB. The receiver receives a TB sequence with multiple CBs tagged with CRCs 405. The receiver performs decoding of each CB in a pipeline 410.

Alternatively, the decoding of each CB may be done sequentially starting with the first CB. If there is a CB that is CB CRC failed 415, the receiver may stop decoding the remaining CBs 420. The receiver signals to the transmitter a NACK along with a CB starting index for retransmission (CBSIRT) 425. The CBSIRT represents, in bits, the point where the transmitter needs to start retransmitting. This point may be the index of a CB in the TB. Further details about CB index signaling are provided in a subsequent section.

When the transmitter retransmits the TB starting with the CBSIRT point (which is greater than one (1)) and uses the same number of physical bits as in the previous transmission, the overall code rate of the retransmitted CB in the TB is lower than that in the previous transmission. The numbers of physical bits are given by a product of the number of resource elements and number of bits per subcarrier. It implies a higher coding gain in the retransmission by not retransmitting the successfully decoded bits (e.g., first i CBs) in the TB. Alternatively, if the resources used for the successfully decoded bits or CBs in the previous transmission are allocated to other data transmissions, then the spectral efficiency may be improved accordingly.

As the receiver receives the CB CRC failed CBs (i.e., (i+1)^{th} CB, (i+2)^{th} CB, . . . , K^{th} CB) during a HARQ retransmission 430, the receiver performs HARQ combining by combining the received CBs with the corresponding previously CB CRC failed CBs 435. The receiver performs turbo decoding and CB CRC checking of the individual HARQ combined CBs 440, starting with the first CB CRC failed CB. These steps are repeated if there are any remaining CB CRC failed CBs. The successfully decoded CBs (i.e., CB CRC passed CBs at 415) within a TB are CRC checked using TB CRC 450. The decoded CBs may be buffered in a memory with a decoded CB data format 455. The receiver signals an ACK to the transmitter 460. As a result, during a HARQ retransmission, the receiver may avoid performing any unnecessary processing of the successfully decoded CBs in the previous transmission(s): de-rate matching, HARQ combining, and turbo decoding. The receiver may decode up to first failed CB. Alternatively, the receiver may decode all it has the ability to and does not re-decode the previously successful CBs.

In one embodiment, when a successive interference cancellation (SIC) receiver is used for data demodulation/detection in MIMO, particularly spatial multiplexing (SM)-MIMO, the successfully decoded CBs may be utilized in the SIC processing. That is, in this case, SIC is implemented on a CB basis (i.e., CB based SIC). For example, in a case of 2×2 SM-MIMO transmission with two codewords (i.e., two TB), a CB CRC passed CBs in a TB (i.e., codeword) may be used for SIC processing of predefined number of CBs of the other TB. In a case where all of the CBs within a TB are CB CRC passed 415, then the TB is CRC checked using TB CRC 450. The receiver signals an ACK to the transmitter 460.

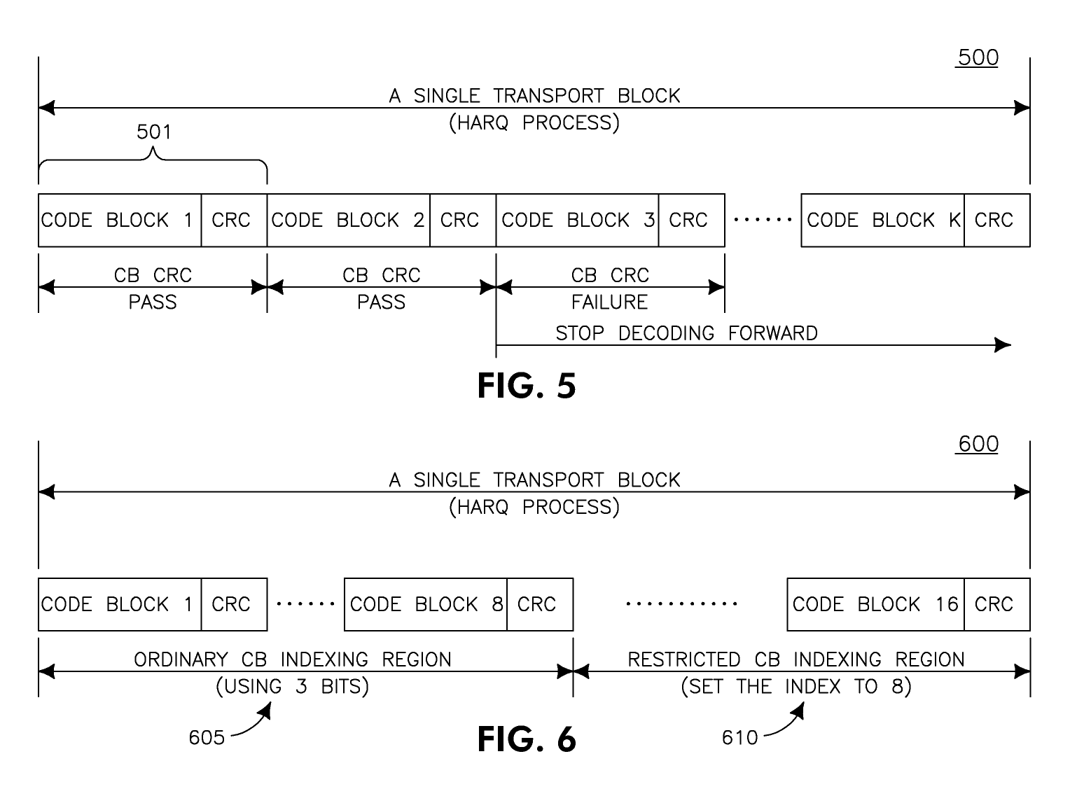

FIG. 5 illustrates a flow diagram of a CB based HARQ retransmission 500. If a TB has a CB CRC failed (condition 415 in FIG. 4), then there may be a small probability that only a few CBs have failed. This may occur when the received CBs experience correlated fading channels. In this case, it may be beneficial to use slightly different code rates, or more generally, different MCS, in each CB to facilitate the effectiveness of index signaling, while maintaining a given overall TB code rate or effective code rate.

For example, a lower code rate is used on the first CB 501 and then the code rate is increased in each successive block as shown in FIG. 5. In one embodiment the code rate span may be kept small. The probability of CB failure increases with the index of the CB. Therefore, the resulting CBSIRT is likely to be higher for a given overall TB failure, making the retransmission smaller since fewer CBs would need to be retransmitted. Variation in the MCS is related to the probability of requiring partial retransmission; however, with a smaller number of CBs in each partial retransmission. In one embodiment the MCS deltas (or delta MCS) are signaled in higher layers to avoid any increase in control channel payload.

The same concepts may also be applied to MIMO transmissions where multiple TBs are transmitted by use of spatial multiplexing, particularly in cases where the correlation of TB performance is created by the transmission technique. One technique is to spread the information content of each TB over all the spatial layers of the multi-TB transmission. In this case, there may be multiple CBs in each of the multiple TBs and each such CB may use the delta MCS to make CBSIRT more efficient.

The CBSIRT may be done on a per TB basis or bundled over all TBs, e.g. only the lowest CBSIRT of all TBs is signaled in order to reduce overhead. The delta MCS may be signaled by higher layers for each TB relative to the effective or reference MCS of each TB. Alternatively, the delta MCS for each CB in all TBs may be signaled by higher layers relative to a single reference so that only a single reference MCS needs to be signaled on the physical (PHY) layer even for multiple TB transmissions. This technique would also be useful in facilitating SIC reception by making certain TBs more robust than others and certain CBs in some TBs more robust than other CBs in other TBs.

To make the above mentioned signaling mechanism more efficient, the code rate (or MCS) of the individual CBs in a given TB may be an increasing function of CB index with a small amount of offset. In one embodiment, the overall TB code rate remains the same. For example, when a TB is segmented into three CBs and is transmitted using 0.5 code rate, the code rate of each CB may be given as follow: code rates of the 1^{st} CB being approximately 0.48, 2^{nd} CB being approximately 0.50, and 3^{rd} CB being approximately 0.52 such that the overall code rate (or effective code rate) remains 0.5.

In one embodiment, such multiple code rates (or MCSs) are given through higher layer signaling. This may also provide Node-B 120 with supplemental and high resolution CQI information, and reduce the need for accurate CQI information.

Several options for signaling the CBSIRT for HARQ retransmission in an efficient manner are described. In transmissions with multiple CBs, the HARQ scheme requires that the receiver signals the transmitter a CBSIRT along with a NACK when there is at least one CB CRC failed CB within a TB. As the number of CBs in a TB varies in a range of one (1) to N (for example, N=sixteen (16)) according to scheduling, the number of bits used for signaling the CBSIRT may also vary accordingly. One of the options for the CBSIRT signaling is signaling with limited index bits. In a case that only the first half of the CBs are indexed, then the number of index bits is reduced by one. This is illustrated in FIG. 6.

FIG. 6 shows an example that has a total sixteen (16) CBs. If the first CB CRC failure occurs between CB 1 and CB 8, then the CB indexing is performed in an ordinary manner (i.e., using three (3) bits) 605. If the first CB CRC failure occurs between CB 9 and CB 16, then the value of the CBSIRT is set to eight (8) (i.e., using three (3) bits) 610. To further reduce the number of CBSIRT bits, the index may be limited to the first one fourth part of the CBs. Alternatively, it is also possible to reduce the total number of CB CRCs to check, by using CRCs that span multiple CBs in such a way that they are aligned with limited indexes; for example, in the example above, a single CRC that spans CB 9 through 16.

Given that a TB CRC failure occurs, it is likely that the first CB CRC failure occurs early. Accordingly, signaling with limited index bits may be a good option, comprising a tradeoff between performance and overhead. This option limits the indexing to some portion of CBs.

Another option for CB index signaling for HARQ retransmission is signaling with full bits. In one embodiment, for a predefined total number of CBs, where K>1, n bits are used to indicate a CBSIRT for HARQ retransmission where n=┌ log₂ (K)┐. For example, there are sixteen (16) CBs, and the number of bits required for the signaling is four (4).

Additionally, a bitmap based signaling option is also described for CB index signaling for HARQ retransmission. A method to indicate the status of the CBs is to use a bitmap. In this bitmap, one bit is used for one CB. For example, one (1) means a successful transmission and zero (0) means an unsuccessful transmission. This method may give high feedback overhead. A total of sixteen (16) bits are needed for sixteen (16) CBs. The ACK or NACK information is already in the bitmap, so an additional signaling for ACK or NACK is not needed.

One method to reduce signaling overhead is to group the CBs and generate a single bit for each group. The bit indicates that all of the CBs in the group were received, and at least one of them was in error. Additional signaling for the ACK or the NACK is not necessary. For example, assume that there are total four (4) groups as follows: first group that includes CBs 1-4, second group that includes CBs 5-8, third group that includes CBs 9-12, and fourth group that includes CBs 13-16. In this case, the CBSIRT consists of four (4) bits. If a group is in error, then all of the CBs in that group are retransmitted.

This method generates ACK or NACK information per CB or per CB group. The index of the CB or the CB group may also be transmitted, similar to the limited indexing. Also, the ACK or the NACK information may be implicitly included in the data. In this case, the WTRU 110 is configured to stop decoding the data as soon as there is a CRC error and the index is transmitted. The WTRU 110 may be configured to continue decoding, but the decoded information is usually not used.

In another embodiment, the WTRU 110 is configured generate an index of the last CB or CB group that was successfully received, or, equivalently, the index of the future CBs that need to be retransmitted. For example, assume the same four (4) groups as above and from which the second group is in error. The WTRU 110 in this example is configured to send the index of CB0 (the last successful transmission) or CB1 (from where the WTRU 110 needs a retransmission). In this case two (2) bits are needed. The ACK or the NACK with one additional bit needs to be signaled; however, this information is already included in the signaling. For example, if all CBs were detected successful, the signal is three (3) (for CB3 out of CB0, CB1, CB2, and CB3), which means that the last successfully received CB was CB3 (i.e. all CBs are correct). This means that the ACK or the NACK data is already transmitted.

In another embodiment, the information from the WTRU 110 may be in error, and the Node-B 120 may not receive the information. Also, control data is not protected with a CRC. Therefore, an ACK mechanism is required. If a CRC is applied to the control data, then the ACK may be achieved by a single bit which the Node-B 120 transmits to the WTRU 110. The bit indicates whether the Node-B 120 retransmits the CBs required by the WTRU 110. If there is no CRC applied to the control data, the Node-B 120 may need to signal the index of the CBs being retransmitted. Therefore, additional bits in the downlink grant are needed. The structure may be similar to the above, and the bits may point to a CB or a CB group.

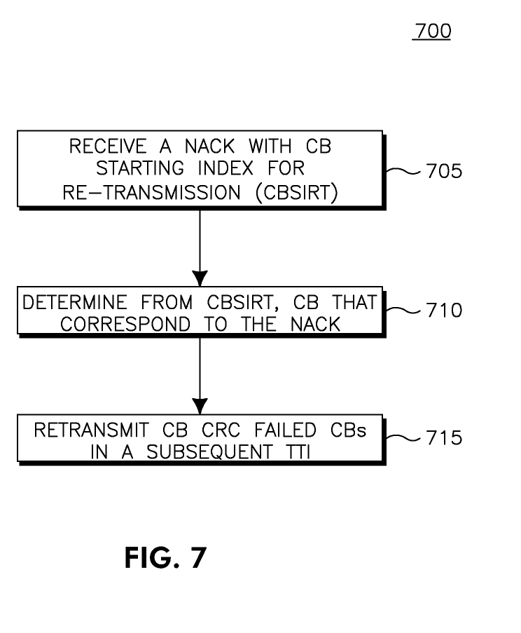

FIG. 7 shows a flow diagram of the HARQ retransmission process. The transmitter is configured to receive a NACK with the CB starting index for retransmission (CBSIRT) 705. The transmitter is configured to determine, from the CBSIRT, a CB that corresponds to the NACK 710. The transmitter is configured to retransmit the CB CRC failed CBs in an appropriate subsequent TTI 715.

Alternatively, a piggybacked retransmission with a new TB or HARQ process is also possible. For the purpose of making full use of the available resources, a small retransmission, in terms of radio resources, may be piggybacked with a new transmission. Additionally, two active TBs or HARQ processes may be concurrent.

The above has various advantages and they are described hereinafter.

One of the advantages is the result of increased coding gain in the retransmission. When the transmitter does not retransmit CB CRC passed CBs, if any, and applies the same MCS and the number of RBs for the current retransmission as was used for the previous transmission or retransmission, then the effective coding rate of the current retransmission becomes lower. This results in an increased coding gain in the retransmission, improving performance. In this case, the coding gain increment is proportional to the number of the CB CRC passed CBs.

Another advantage is increased spectral efficiency. If the transmitter allocates the RBs which were used for the CB CRC passed CBs in the previous transmission or retransmission to other transmissions, then the overall spectral efficiency is increased. Alternatively, in one embodiment, when a retransmission occurs with smaller RBs, the newly freed-up RBs are used to carry the data for a different HARQ process. For example, if the WTRU 110 has two large TBs that are CB CRC failed, and they each have only one CB to transmit, then the two CBs may be packaged into the next appropriate TTI.

Also, power saving at the receiver by processing only the CB CRC failed CBs during a HARQ retransmission is also an advantage.

Overhead of feedback signaling may be increased from the receiver due to the introduction of the additional CBSIRT for a NACK. For an ACK, the additional index signaling is not needed. Therefore, ACK/NACK signaling is asymmetrical in terms of the number of ACK/NACK bits. Alternatively, the index may effectively replace both ACK and NACK. For example, an ACK may just be one of the possible indications in the index.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for hybrid automatic repeat request (HARQ) transmission in a receiver, the method comprising:
receiving a transport block that is segmented into a plurality of code blocks (CBs), each CB having an attached cyclic redundancy check (CRC);
decoding each of the plurality of CBs with attached CRC; and
determining whether each CRC fails, and in response to a determination that a CRC has failed, transmitting a CB index number of the CB attached to the CRC that has failed.

2. The method as in claim 1, further comprising:
receiving a HARQ retransmission including CB attached to the CRC that has failed; and
HARQ combining CBs received in the HARQ retransmission with previously CRC failed CBs.

3. The method as in claim 2 wherein the HARQ retransmission includes a CB that has not been previously transmitted.

4. The method as in claim 1, further comprising:
assigning different code rates to each of the plurality of CBs.

5. The method as in claim 4 wherein different code rates of the CBs are assigned in a monotone order based on the CB index.

6. The method as in claim 1, further comprising:
assigning a different modulation and coding schemes (MCSs) to each of the plurality of CBs.

7. The method as in claim 6, further comprising transmitting the different MCSs in layer 2 signaling, in layer 3 signaling, or in system information.

8. The method as in claim 1 wherein the receiver is located in a wireless transmit receive unit (WTRU).

9. The method as in claim 1 wherein the receiver is located in a base station.

10. A method for hybrid automatic repeat request (HARQ) transmission in a receiver, the method comprising:
receiving a plurality of transport blocks, each of the transport blocks are segmented into a plurality of code blocks (CBs), each CB having an attached cyclic redundancy check (CRC);
decoding each of the plurality of CBs with attached CRC; and
determining whether each CRC fails, and in response to a determination that a CRC has failed, transmitting a CB index number of the CB attached to the CRC that has failed.

11. The method as in claim 10, further comprising:
receiving a HARQ retransmission including CB attached to the CRC that has failed; and
HARQ combining CBs received in the HARQ retransmission with previously CRC failed CBs.

12. The method as in claim 10, further comprising:
assigning different code rates to each of the plurality of CBs.

13. The method as in claim 12 wherein different code rates of the CBs are assigned in a monotone order based on the CB index.

14. The method as in claim 10, further comprising:
assigning a different modulation and coding schemes (MCSs) to each of the plurality of CBs.

15. The method as in claim 10, further comprising transmitting the different MCSs in layer 2 signaling, in layer 3 signaling, or in system information.

16. The method as in claim 10 wherein the receiver is located in a wireless transmit receive unit (WTRU).

17. The method as in claim 10 wherein the receiver is located in a base station.

18. A method for hybrid automatic repeat request (HARQ) retransmission in a transmitter, the method comprising:
receiving an index number of a code block (CB) for retransmission (CBSIRT) attached with a cyclic redundancy check (CRC) that has failed;
determining the CB that correspond to the CRC that has failed based on the CBSIRT; and
retransmitting the failed CB in a subsequent transmission time interval (TTI).

19. The method as in claim 18 wherein the transmitter is located in a wireless transmit receive unit (WTRU).

20. The method as in claim 18 wherein the transmitter is located in a base station.
